(19) United States
(12) Patent Application Publication
(10) Pub. No.: US 2013/0039819 A1
(43) Pub. Date: Feb. 14, 2013

(54) VAPOR CHAMBER AND METHOD OF MANUFACTURING SAME

(71) Applicant: Chih-Peng Chen, New Taipei City (TW)

(72) Inventor: Chih-Peng Chen, New Taipei City (TW)

(73) Assignee: ASIA VITAL COMPONENTS CO., LTD., New Taipei City (TW)

(21) Appl. No.: 13/205,639

(22) Filed: Aug. 9, 2011

(51) Int. Cl. B01J 7/00; B23P 11/00

(52) U.S. Cl. 422/305; 137/15.01

(57) ABSTRACT

A vapor chamber and a method of manufacturing same are disclosed. The vapor chamber includes a main body internally defining a chamber. The chamber internally has a plurality of flow guides and contains a working fluid; and at least one flow passage is formed between any two adjacent flow guides, such that the flow guides and the flow passages together define a flow guiding zone in the main body. The flow guiding zone has two opposite ends respectively connecting with a first convection zone and a second convection zone, such that the flow passages and the first and second convection zones communicate with one another. With the main body and the internal flow passages for a vapor chamber being integrally formed by aluminum extrusion, the time, labor and material costs for the vapor chamber can be largely reduced.

### FIELD OF THE INVENTION

The present invention relates to a vapor chamber, and more particularly to a vapor chamber that is integrally formed by aluminum extrusion and accordingly enables largely reduced material and manufacturing costs. The present invention also relates to a method of manufacturing the above-described vapor chamber.

### BACKGROUND OF THE INVENTION

The currently most popular heat transfer elements include heat pipes, vapor chambers and flat heat pipes, all of them are metal elements providing good heat conductivity. The heat pipe is mainly used to transfer heat to a distant location. The heat pipe includes an end, at where heat is absorbed to transform a liquid-phase working fluid in the heat pipe into vapor phase to thereby transfer the absorbed heat to another opposite end of the heat pipe to achieve the purpose of transferring heat.

The vapor chamber is usually selected for use as a heat transfer element at a location with a relatively large heat transfer area. The vapor chamber has one side surface in contact with a heat source for absorbing heat, and the absorbed heat is transferred to another opposite side surface, from where the heat is dissipated into ambient space and a working fluid filled therein is condensed.

Conventionally, the vapor chamber is mainly made of a copper material to define an internal chamber, in which a supporting structure and a wick structure are provided. The internal chamber of the vapor chamber is then evacuated and filled with a working fluid before being sealed. Liquid-vapor circulation of the working fluid in the internal chamber of the vapor chamber continues to achieve the effect of heat transfer.

The conventional vapor chamber usually includes an upper plate and a lower plate that are closed to each other to define the internal chamber therebetween. The supporting structure and the wick structure are mainly formed by sintering, milling or etching inner surfaces of the upper and lower plates, or providing a mesh-like structure in the internal chamber. All these supporting and wick structures require a lot of time and labor to form and therefore increase the manufacturing costs of the vapor chamber.

Further, since the conventional vapor chamber is made of a copper material, it has good heat transfer efficiency but requires relatively high material cost. In brief, the conventional vapor chamber has the following disadvantages: (1) requiring high manufacturing costs; and (2) uneasy to manufacture.

### SUMMARY OF THE INVENTION

A primary object of the present invention is to provide a vapor chamber that achieves upgraded liquid-vapor circulation therein and requires only reduced manufacturing costs.

Another object of the present invention is to provide a method for manufacturing a vapor chamber at reduced manufacturing cost while achieving upgraded liquid-vapor circulation in the vapor chamber.

To achieve the above and other objects, the vapor chamber according to the present invention includes a main body internally defining a chamber. The chamber internally has a plurality of flow guides and contains a working fluid; and at least one flow passage is formed between any two adjacent flow guides, such that the flow guides and the flow passages together define a flow guiding zone in the main body. The flow guiding zone has two opposite ends respectively connecting with a first convection zone and a second convection zone, such that the flow passages and the first and second convection zones communicate with one another.

To achieve the above and other objects, the vapor chamber manufacturing method according to the present invention includes the following steps: integrally forming a main body internally having a plurality of flow passages by way of aluminum extrusion; machining two ends of the main body for the flow passages to communicate with one another; and closing the two ends of the main body, evacuating the closed main body, and filling a working fluid into the evacuated main body.

With the vapor chamber of the present invention, it is able to largely upgrade the liquid-vapor circulation in the vapor chamber and accordingly, achieve upgraded heat transfer efficiency.

The present invention is characterized by integrally forming the main body of the vapor chamber by aluminum extrusion, so that internal flow passages are simultaneously formed along with the main body to reduce the time, labor and material costs needed to manufacture the vapor chamber.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a perspective view of a vapor chamber according to a first embodiment of the present invention;

FIG. 2a is a sectional view taken along line A-A of FIG. 1;

FIG. 2b is a sectional view taken along line B-B of FIG. 1;

FIG. 3 is a cross sectional view of a vapor chamber according to a second embodiment of the present invention;

FIG. 4 illustrates a vapor chamber manufacturing method according to a first embodiment of the present invention;

FIG. 5 is a flowchart showing the steps included in the vapor chamber manufacturing method according to the first embodiment of the present invention; and

FIG. 6 is a flowchart showing the steps included in the vapor chamber manufacturing method according to a second embodiment of the present invention.

### DETAILED DESCRIPTION OF THE PREFERRED EMBODIMENTS

The present invention will now be described with some preferred embodiments thereof and with reference to the drawings. For the purpose of easy to understand, elements that are the same in the preferred embodiments are denoted by the same reference numerals.

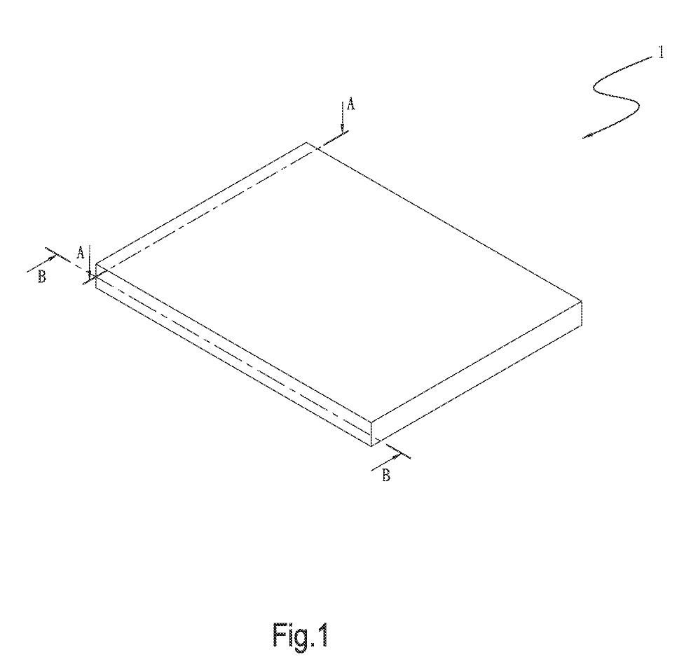

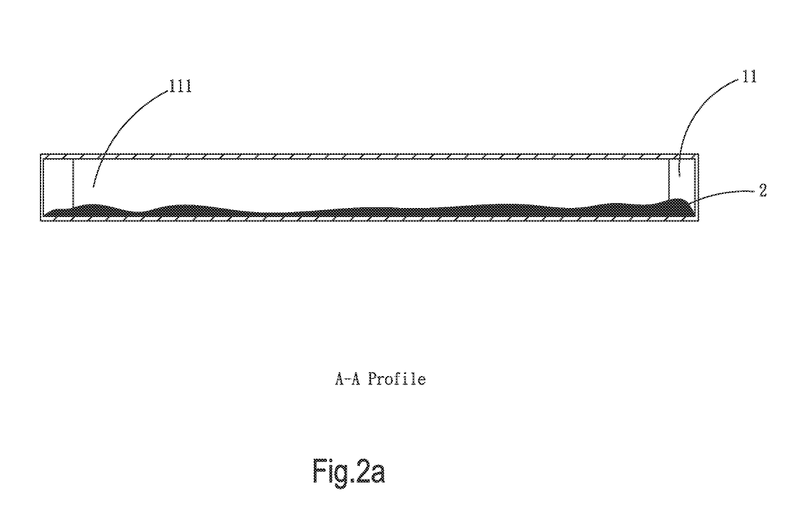

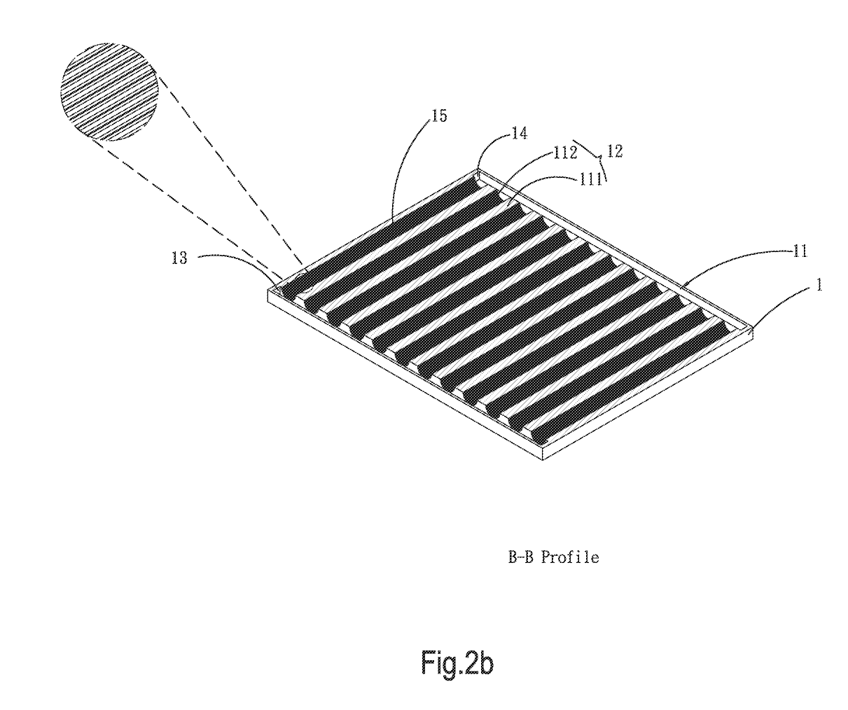

Please refer to FIG. 1 that is a perspective view of a vapor chamber according to a first embodiment of the present invention, and to FIGS. 2a and 2b that are sectional views taken along lines A-A and B-B of FIG. 1, respectively. As shown, the vapor chamber according to the present invention includes a main body 1.

The main body 1 is integrally formed by way of aluminum extrusion to define a chamber 11 therein. The chamber 11 internally has a plurality of flow guides 111 and contains a working fluid 2. At least one flow passage 112 is formed between two adjacent ones of the flow guides 111, such that the flow guides 111 and the flow passages 112 together define a flow guiding zone 13 in the main body 1. The flow guiding zone 13 has two opposite ends respectively connecting with a first convection zone 13 and a second convection zone 14, such that the flow passages 112 and the first and second convection zones 13, 14 communicate with one another. The chamber 11 is internally provided on wall surfaces thereof with at least one type of wick structure 15, which can be any one of grooves, a sintered powder layer, or mesh structures. In the illustrated first embodiment, the wick structure 15 is configured as a plurality of grooves without being limited thereto.

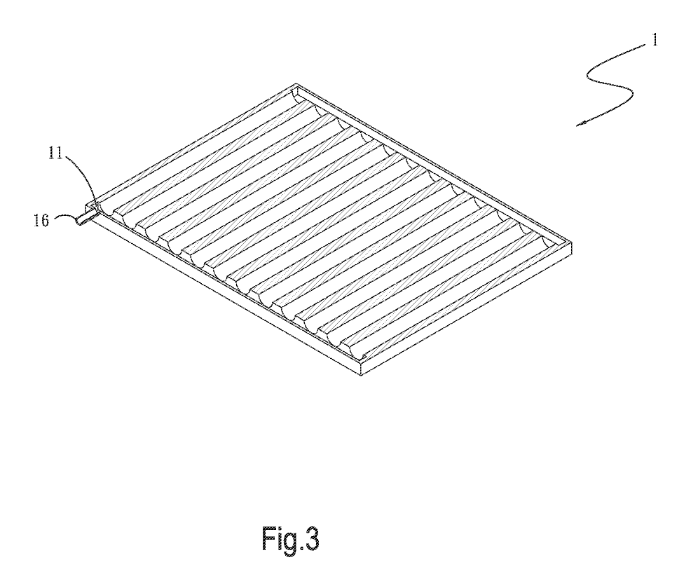

Please refer to FIG. 3 that is a sectional view of a vapor chamber according to a second embodiment of the present invention. As shown, the second embodiment is generally structurally similar to the first embodiment, except for a pipe 16 that is further provided to communicate with the chamber 11.

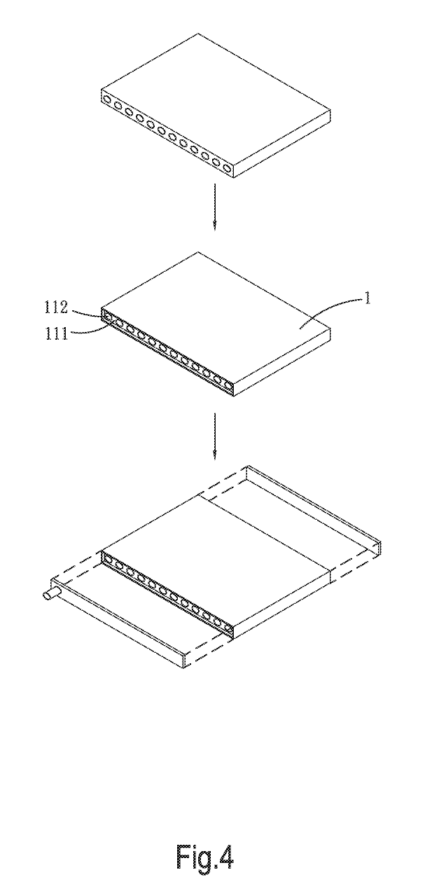

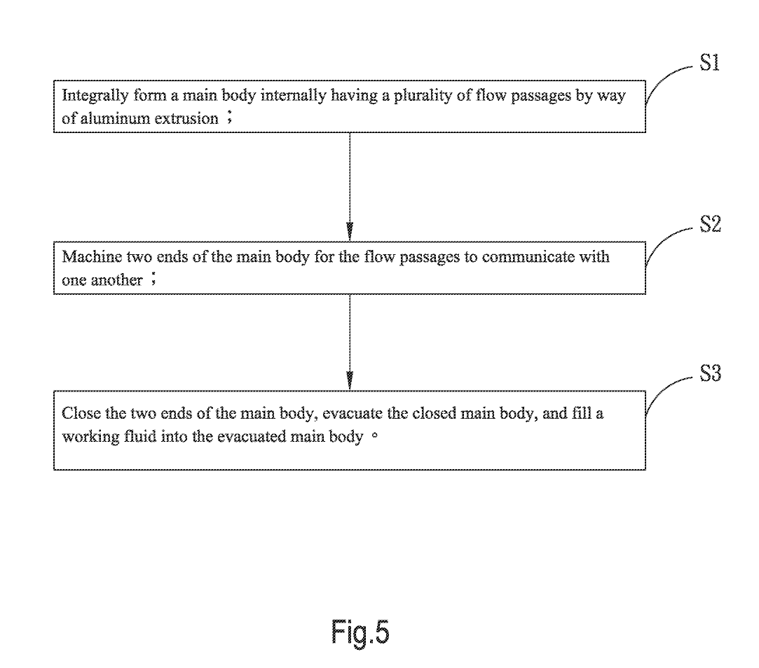

FIG. 4 illustrates a vapor chamber manufacturing method according to a first embodiment of the present invention, and FIG. 5 is a flowchart showing the steps included therein. The vapor chamber manufacturing method is now described with reference to FIGS. 4 and 5 along with FIGS. 1 and 2b.

In a first step S1, a main body internally having a plurality of flow passages is integrally formed by way of aluminum extrusion.

More specifically, at least one main body 1 for vapor chamber is integrally formed by way of aluminum extrusion, such that a chamber 11 internally having a plurality of flow guides 111 and flow passages 112 is defined in the main body 1.

In a second step S2, the main body is machined at two opposite ends for the flow passages to communicate with one another.

More specifically, two open ends of the aluminum-extruded main body 1 are machined, so that the flow guides 111 are partially removed at respective two ends, allowing the flow passages 112 defined between adjacent flow guides 111 to communicate with one another. The main body 1 can be machined by way of milling or planning.

And, in a third and final step S3, the two opposite ends of the main body are closed, and the closed main body is then evacuated and filled with a working fluid.

More specifically, the two open ends of the main body 1 are closed, and the closed main body 1 is evacuated and filled with a working fluid 2.

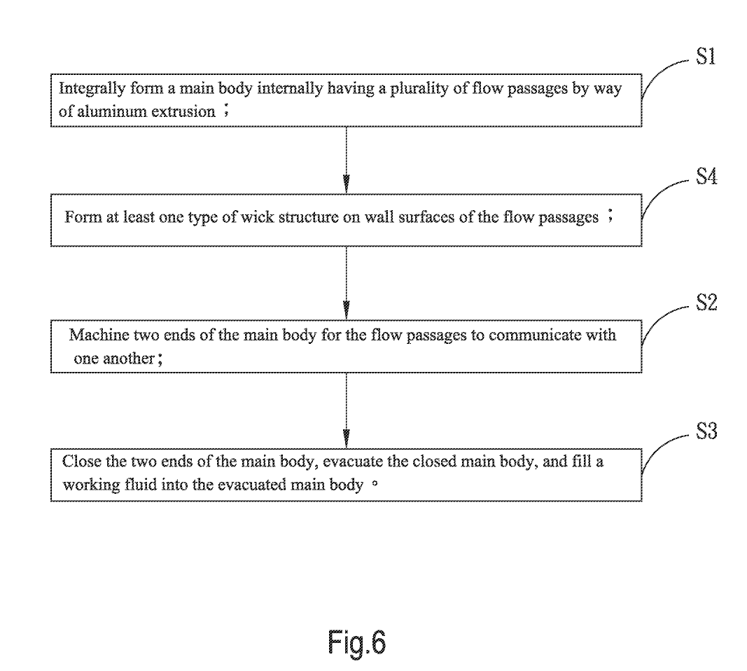

Please refer to FIG. 6 that is a flowchart showing the steps included in a vapor chamber manufacturing method according to a second embodiment of the present invention. As shown, the vapor chamber manufacturing method in the second embodiment is generally similar to the first embodiment and includes a step S1, in which a main body internally having a plurality of flow passages is integrally formed by way of aluminum extrusion; a step S2, in which the main body is machined at two opposite ends for the flow passages to communicate with one another; and a step S3, in which the two opposite ends of the main body are closed, and the closed main body is then evacuated and filled with a working fluid. However, the second embodiment is different from the first embodiment in having a further step S4, which is performed after the step S1.

In the step S4, at least one type of wick structure is formed on wall surfaces of the flow passages.

More specifically, at least one type of wick structure 15 is formed on wall surfaces of the flow passages 112 in the main body 1, and the wick structure 15 can be any one of grooves, a sintered powder layer, and mesh structures.

The present invention has been described with some preferred embodiments thereof and it is understood that many changes and modifications in the described embodiments can be carried out without departing from the scope and the spirit of the invention that is intended to be limited only by the appended claims.

What is claimed is:

1. A vapor chamber, comprising a main body internally defining a chamber; the chamber internally having a plurality of flow guides and containing a working fluid; at least one flow passage being formed between any two adjacent ones of the flow guides, such that the flow guides and the flow passages together define a flow guiding zone in the main body; and the flow guiding zone having two opposite ends respectively connecting with a first convection zone and a second convection zone, such that the flow passages and the first and second convection zones communicate with one another.

2. The vapor chamber as claimed in claim 1, wherein the chamber is internally provided on wall surfaces thereof with at least one type of wick structure.

3. The vapor chamber as claimed in claim 2, wherein the wick structure is selected from the group consisting of grooves, a sintered powder layer, and mesh structures.

4. The vapor chamber as claimed in claim 1, wherein the main body further includes a pipe communicating with the chamber.

5. A method of manufacturing vapor chamber, comprising the following steps:
integrally forming a main body internally having a plurality of flow passages by way of aluminum extrusion;
machining two ends of the main body for the flow passages to communicate with one another; and
closing the two ends of the main body, evacuating the closed main body, and filling a working fluid into the evacuated main body.

6. The vapor chamber manufacturing method as claimed in claim 5, wherein the main body is machined by a manner selected from the group consisting of milling and planning.

7. The vapor chamber manufacturing method as claimed in claim 5, further comprising a step of forming at least one type of wick structure on wall surfaces of the flow passages, being performed after the step of integrally forming the main body internally having a plurality of flow passages by way of aluminum extrusion.

8. The vapor chamber manufacturing method as claimed in claim 7, wherein the wick structure is selected from the group consisting of grooves, a sintered powder layer, and mesh structures.
